(19) United States
(12) Patent Application Publication
(10) Pub. No.: US 2011/0161157 A1
(43) Pub. Date: Jun. 30, 2011

(54) ON-LINE ADVERTISEMENT DATA OUTPUT CONTROL SYSTEM AND METHOD OF THE SAME

(76) Inventors: Ki-won Nam, Seoul (KR); Ji-hyuk Cha, Seoul (KR); Pyong-taek Kim, Seoul (KR)

(21) Appl. No.: 12/522,975

(22) PCT Filed: Apr. 2, 2009
(86) PCT No.: PCT/KR2009/001701

§ 371 Date: Jul. 13, 2009

(30) Foreign Application Priority Data
Apr. 2, 2008 (KR) 10-2008-0030628

(51) Int. Cl. G06Q 30/00

(52) U.S. Cl. 705/14.31; 705/14.1; 705/14.34

(57) ABSTRACT

The present invention relates to an advertisement data output control system and a method of the same, the advertisement data output control system including: a communication unit which communicates with a user terminal; a storage which stores a plurality of advertisement informations and incentive informations corresponding to the plurality of advertisement informations, respectively; and a controller which renews the incentive information to vary the amount of incentive corresponding to the advertisement information concerned according to a predetermined incentive varying factor, and controls the plurality of advertisement informations to be arranged in order of the amount of incentive and displayed in the user terminal. With this, it is possible to effectively induce a user to access advertisement information and an advertiser to participate in running an advertisement.

### TECHNICAL FIELD

The present invention relates to an advertisement data output control system and a method of the same, and more particularly to an advertisement data output control system, which arranges and displays a plurality of advertisement data for sales of a product or service, and a method of the same.

### BACKGROUND ART

An on-line advertisement market and an on-line shopping market have been designed for effectively exposing advertisement or shopping information to a customer and leading to sale of a product or service (hereinafter, referred to as “goods”), in which various advertising techniques and shopping encouraging techniques have been introduced to achieve such an end.

For example, the present applicant has filed for patents titled “MANY MEMBERS POINT ADDING SYSTEM FOR BUYING POINT OF THE BUYING MEMBER AND METHOD OF THE SAME (Korean Patent Application Nos. 10-2006-45900 and 10-2006-56655)” in which reward points given to many customers when getting access to an advertisement are combined and processed to be accumulated in real time, and the accumulated reward points are provided as a discount for payment when one of the customers makes a purchase, thereby encouraging the access to the advertisement and the shopping.

However, from an advertiser's standpoint, the “MANY MEMBERS POINT ADDING SYSTEM FOR BUYING POINT OF THE BUYING MEMBER AND METHOD OF THE SAME” have a problem that a web site or an advertisement where reward points to be earned are relatively low is less accessed than a web site or an advertisement where reward points to be earned are relatively high.

Further, in the case of “MANY MEMBERS POINT ADDING SYSTEM FOR BUYING POINT OF THE BUYING MEMBER AND METHOD OF THE SAME,” an advertisement fee is charged by taking only user's accesses to the advertisement information into account without considering sales of the advertiser, and thus there is a problem that the advertisement fee is not substantially matched with the sales.

Meanwhile, a conventional portal site, online shopping mall, or etc. charges the advertisement fees differentially according to ranks for a plurality of advertisement informations run at the same time. That is, the advertiser should pay more advertisement fees to give the advertisement information a higher rank.

However, such an advertisement information ranking method has a problem that more sales of goods corresponding to the advertisement information cannot be ensured even though more advertisement fees are paid for giving the precedence to the advertisement information and thus the advertisement information is more accessed. Also, this advertisement information ranking method has a problem that the advertiser may be deceived into paying more advertisement fee, i.e., a so-called “click fraud” may occur.

In the meantime, in the case of “MANY MEMBERS POINT ADDING SYSTEM FOR BUYING POINT OF THE BUYING MEMBER AND METHOD OF THE SAME,” when many users try to make a purchase, reward points are given to only one user who first make the purchase and the other users are deprived of the reward points concerned, so that customers' interest is lowered and sales promotion for goods becomes ineffectual.

### DISCLOSURE

### Technical Problem

Accordingly, the present invention is conceived to solve the foregoing conventional problems, and an aspect of the present invention is to provide an advertisement data output control system and a method of the same, which can effectively induce both a user to access advertisement information and an advertiser to participate in running an advertisement in respect that a plurality of advertisement informations is ranked and displayed.

Another aspect of the present invention is to provide an advertisement data output control system and a method of the same, which can allow an advertiser to pay a reasonable advertisement fee in respect that a plurality of advertisement informations is ranked and displayed.

Still another aspect of the present invention is to provide an advertisement data output control system and a method of the same, which can prevent a user from being induced to make a click fraud in respect that a plurality of advertisement informations is ranked and displayed.

Yet another aspect of the present invention is to provide an advertisement data output control system and a method of the same, which can further encourage customers' interest and more effectively promote sales of goods.

### Technical Solution

The foregoing and/or other aspects of the present invention can be achieved by providing an advertisement data output control system including: a communication unit which communicates with a user terminal; a storage which stores a plurality of advertisement informations and incentive informations corresponding to the plurality of advertisement informations, respectively; and a controller which renews the incentive information to vary the amount of incentive corresponding to the advertisement information concerned according to a predetermined incentive varying factor, and controls the plurality of advertisement informations to be arranged in order of the amount of incentive and displayed in the user terminal. Thus, it is possible to more effectively induce a user to have the access to all the plural advertisement informations. Further, the ranks of the plural advertisement informations are flexibly changed, so that the access to the advertisement can be prevented from being focused on a certain advertisement information and an advertiser can be effectively induced to participate in running the advertisement.

The incentive varying factor may include at least one user's access to the advertisement information, and the amount of incentive increases depending on the amount of user's access to the corresponding advertisement information. Thus, the advertisement information having more accesses occupies a higher rank, so that the advertisement fee can be more reasonably charged.

The controller may stop variation of the corresponding incentive if the amount of user's access to a certain advertisement information is less than a predetermined value. Thus, the advertisement fee is prevented from wastefully paid with respect to an advertisement having no substantial effect on the access.

The storage may further store information about an increase rate previously set with respect to each of the plural advertisement informations, and the controller may determine the amount of incentive on the basis of the increase rate. Thus, the advertisement information having the higher reserve rate occupies a higher rank more quickly, so that the advertisement fee can be more reasonably paid by allowing an advertiser to set up the increase rate at his/her disposal and to adjust the rank of the corresponding advertisement information.

The increase rates of the plural advertisement informations may be set differentially according to ranks of the plural advertisement informations. Thus, the reserve rates can be set more variously and specifically, so that the advertisement fee can be more reasonably charged.

The controller may renew the information about the increase rate so that the increase rate is adjusted with respect to the corresponding advertisement information according to a predetermined increase rate adjusting factor. For example, if the sales to the advertisement fee are low, etc. the increase rate of the corresponding advertisement information is adjusted to increase, thereby allowing the advertisement information to move to the higher rank more quickly and effectively compensating the advertisement fee.

The incentive varying factor may include providing the incentive to the user, and the controller may reduce the incentive as much as provided to the corresponding user. Thus, the ranks of the plural advertisement informations are more flexibly changed, so that the access to the advertisement can be more effectively distributed.

The controller may secure the amount of incentive remained after providing the incentive to be not less than a predetermined minimum value. Thus, when the residual incentive is rapidly decreased as providing the incentive, the residual incentive is prevented from decreasing into a predetermined minimum value or less, thereby securing the corresponding advertisement information to have at least a predetermined rank.

If the incentive is provided to a first user who makes a purchase of a goods, the controller may fulfill an auxiliary incentive process to provide an auxiliary incentive to a second user who has an access to the advertisement information of the corresponding goods before the purchase of the first user and makes a purchase of the corresponding goods after the purchase of the first user. Thus, a compensation is given to even another user who makes a later purchase, thereby maximizing a customer's interest and more effectively promoting the sales of the corresponding goods.

The controller may control the user terminal to display the amount of incentive to correspond to the advertisement information concerned. Thus, it is possible to maximally induce a user to access the advertisement information.

The controller may draw out plural advertisement informations corresponding to a search request of a user from the plurality of advertisement informations, and control the drawn plural advertisement informations to be displayed through the user terminal. Thus, the plurality of advertisement informations are displayed corresponding to the search results, thereby maximizing the advertising effects.

Another aspect of the present invention may be achieved by providing an advertisement data output control method of an advertisement data output control system, the method including: storing a plurality of advertisement informations and incentive informations corresponding to the plurality of advertisement informations, respectively; renewing the incentive information to vary the amount of incentive corresponding to the advertisement information concerned according to a predetermined incentive varying factor; and controlling the plurality of advertisement informations to be arranged in order of the amount of incentive and displayed in the user terminal.

Still another aspect of the present invention may be achieved by providing an advertisement data output control system including: a communication unit which communicates with a plurality of users through user terminals; a storage which stores an advertisement information of a goods, and information about a basic incentive and an auxiliary incentive; and a controller which processes the information about the basic incentive and the auxiliary incentive so that the basic incentive is provided to a first user who makes a purchase of a goods through an access to the advertisement information among the plurality of users, and the auxiliary incentive is provided to a second user who has an access to the advertisement information of the corresponding goods before the purchase of the first user and makes a purchase of the corresponding goods after the purchase of the first user.

Yet another aspect of the present invention may be achieved by providing an advertisement data output control method of an advertisement data output control system, the method including: storing an advertisement information of a goods, and information about a basic incentive and an auxiliary incentive; processing the information about the basic incentive so that the basic incentive is provided to a first user who makes a purchase of a goods through an access to the advertisement information among the plurality of users; and processing the information about the auxiliary incentive so that the auxiliary incentive is provided to a second user who has an access to the advertisement information of the corresponding goods before the purchase of the first user and makes a purchase of the corresponding goods after the purchase of the first user.

### ADVANTAGEOUS EFFECTS

According to an exemplary embodiment of the present invention, an advertisement data output control system and a method of the same, which can manage change of an incentive given to a user in association with advertisement information, and arrange a plurality of advertisement information in order of precedence according to the amount of the incentive, thereby effectively inducing both a user to access the advertise information and an advertiser to participate in running an advertisement. Further, it is possible to allow an advertiser to pay a reasonable advertisement fee and prevent a click fraud. Also, it is possible to more effectively induce a user to access the advertisement and thus further promote sales of goods.

### DESCRIPTION OF DRAWINGS

FIG. 1 is a schematic view of an advertisement data output control system according to an exemplary embodiment of the present invention;

FIG. 2 illustrates ranked advertisement information in the advertisement data output control system according to an exemplary embodiment of the present invention;

FIG. 3 is a block diagram showing configuration of an advertisement data output control server according to an exemplary embodiment of the present invention;

FIG. 4 is a flowchart showing operation of the advertisement data output control system according to an exemplary embodiment of the present invention;

FIG. 5 is a block diagram showing configuration of an advertisement data output control server according to another exemplary embodiment of the present invention;

FIG. 6 is a flowchart showing operation of the advertisement data output control system according to another exemplary embodiment of the present invention;

FIG. 7 illustrates ranked advertisement information in an advertisement data output control system according to still another exemplary embodiment of the present invention;

FIG. 8 is a flowchart showing operation of the advertisement data output control system according to still another exemplary embodiment of the present invention;

FIG. 9 illustrates change in an increase rate in accordance with staying time in the advertisement data output control system according to still another exemplary embodiment of the present invention;

FIG. 10 is a flowchart showing operation of the advertisement data output control system according to still another exemplary embodiment of the present invention;

FIG. 11 illustrates that the advertisement informations are arranged in order of precedence in the advertisement data output control system according to still another exemplary embodiment of the present invention;

FIG. 12 is a flowchart showing operation of the advertisement data output control system according to still another exemplary embodiment of the present invention;

FIG. 13 illustrates change in an increase rate in the advertisement data output control system according to still another exemplary embodiment of the present invention;

FIG. 14 is a flowchart showing operation of the advertisement data output control system according to still another exemplary embodiment of the present invention;

FIG. 15 illustrates a state of counting an accummulatable subscription time in the advertisement data output control system according to still another exemplary embodiment of the present invention;

FIG. 16 illustrates change in accummulatable reward points according to a lapse of time in the advertisement data output control system according to still another exemplary embodiment of the present invention;

FIG. 17 is a flowchart showing operation of the advertisement data output control, system according to still another exemplary embodiment of the present invention;

FIG. 18 is a block diagram showing configuration of the advertisement data output control server according to still another exemplary embodiment of the present invention;

FIG. 19 illustrates settlement of accounts in consideration of a deposit when securing advance payment in the advertisement data output control system according to still another exemplary embodiment of the present invention;

FIG. 20 is a flowchart showing operation of the advertisement data output control system according to still another exemplary embodiment of the present invention;

FIG. 21 is a schematic view of an advertisement data output control system according to still another exemplary embodiment of the present invention;

FIG. 22 illustrates state of an advertisement data output control system according to still another exemplary embodiment of the present invention; and

FIG. 23 is a flowchart showing operation of the advertisement data output control system according to still another exemplary embodiment of the present invention.

### BEST MODE

Hereinafter, an advertisement data output control system according to an exemplary embodiment of the present invention will be described with reference to accompanying drawings.

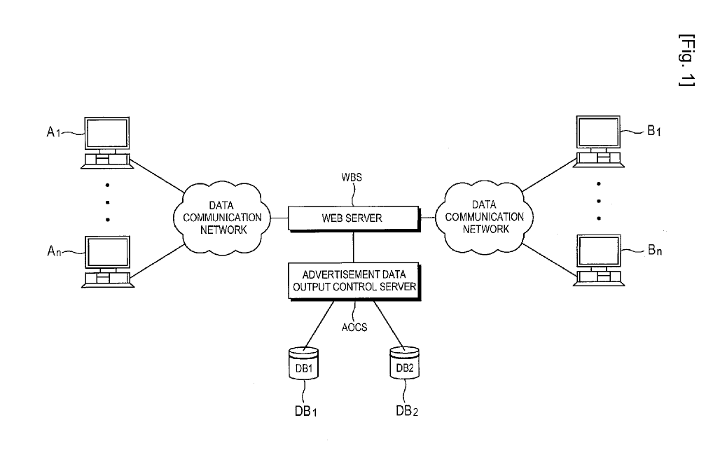

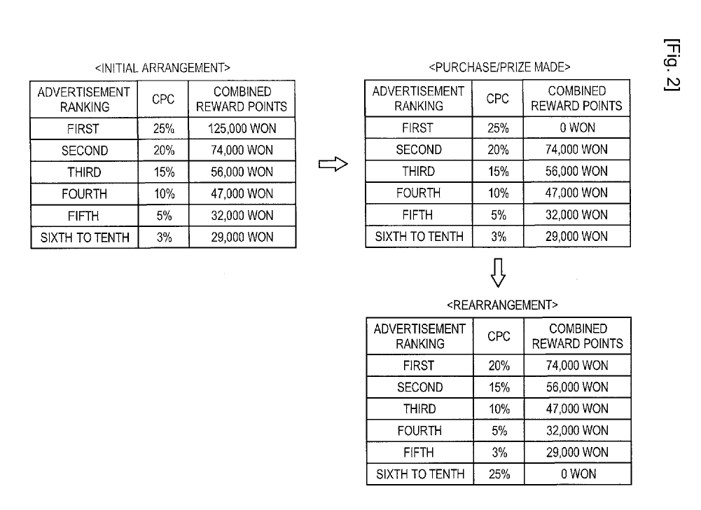

FIG. 1 is a schematic view of an advertisement data output control system according to an exemplary embodiment of the present invention, and FIG. 2 illustrates ranked advertisement information in the advertisement data output control system according to an exemplary embodiment of the present invention.

Referring to FIG. 1, an advertisement data output control system according to an exemplary embodiment of the present invention ranks a plurality of advertisement informations according to the amount of an incentive. In this embodiment, the advertisement information is run by an advertiser to promote sales of goods, and may be displayed as an item to which a user can access on an Internet web page such as a search portal site, a news portal site or an online shopping mall (refer to FIG. 2). Further, the advertisement information may be displayed in the form of a text and/or an image. The plurality of advertisement informations are ranked and displayed according to predetermined rules to notify their precedence. For example, the plurality of advertisement informations are arranged vertically or horizontally in the form of a list, or distributed scatteringly. To give the precedence to the plurality of advertisement information, the advertisement informations may be differentiated by a font size, a color, etc., or various emphasis effects such as highlights, a flash, a dynamic motion, a banner, etc. may be applied to the advertisement information. The plurality of advertisement informations may be located in various positions such as a main area, a side area, a tool bar area, etc. of the web page, and may be achieved in various forms such as pop-up, speech balloons, etc. without limitation.

In this embodiment, an incentive is provided corresponding to the advertisement information so as to intentionally motivate or lead a user to purchase a goods of an advertiser, which is of benefit to a user. In this embodiment, the incentive includes not only economic benefit such as money, spots, services or the like, but also mental benefit such as a predetermined action good for a user as long as its worthy is objectively evaluable. Further, the incentive may be provided in various types, for example, a discount, cash, a merchandise coupon, a coupon, a point, mileage, a further goods in addition to a purchased goods, etc.

In the present embodiment, the plurality of advertisement informations are ranked in order of the amount of corresponding incentive. For example, if the plurality of advertisement informations are vertically arranged on a list, the advertisement information having a large amount of incentive may be higher ranked than that having a relatively small amount of incentive.

The advertisement data output control system according to the present embodiment changes the amount of incentive corresponding to the advertisement information concerned if a predetermined incentive varying factor occurs. In result, the ranks of the plural advertisement informations may vary depending on the change in the amount of incentive. That is, the advertisement data output control system according to the present embodiment allows the advertisement information having a larger amount of the incentive to get a higher rank, so that even a low-ranked advertisement information can have a chance of being more accessed according to the amount of incentive. In other words, the advertisement data output control system according to this embodiment does not determine the rank of the advertisement information according to how much the advertisement fee is paid, but flexibly changes the ranks of the plural advertisement informations according to the amount of incentive provided for a user. According to an exemplary embodiment of the present invention, the incentive directly provided for a user is used as a means for increasing the access to the advertisement information, and it is therefore possible to more effectively induce a user to have the access to all the plural advertisement informations. Further, the ranks of the plural advertisement informations are flexibly changed, so that the access to the advertisement can be prevented from being focused on a certain advertisement information and an advertiser can be effectively induced to participate in running the advertisement. In another respect, it allows an advertiser to pay a reasonable advertisement fee and prevents a click fraud.

In this embodiment, the incentive varying factor may include at least one user's access to the advertisement information. In this embodiment, the access indicates that a user recognizes the advertisement information through five senses, i.e., visually, acoustically or tactually. For example, the access to the advertise includes a click of the advertisement information; propagation of the advertisement information via a mail, a website, introduction or the like; response to the advertisement information such as a reply; etc.

In this embodiment, the amount of incentive may increase according to the amount of users' access to a corresponding advertisement information. The amount of user's access indicates how many times users access the corresponding advertisement information, which is evaluable. For instance, the amount of user's access includes click times, i.e., access times of opening a certain advertisement information pages; access continuous time, e.g., time taken until the corresponding page is closed from time of opening the advertisement information page; the number of occupations, i.e., the number of users concurrently connected to one advertisement information page; etc. Thus, according to the present embodiment, the advertisement information whose the amount of users' access is large is relatively highly ranked as compared with that whose the amount of user's access is small, thereby allowing an advertiser to pay a reasonable advertisement fee.

Further, in this embodiment, the incentive varying factor includes an offer of an incentive to a user. The incentive in this embodiment is given to a user in order to promote sales of goods, so that a corresponding incentive can be given to a user who satisfies a predetermined condition and the amount of the incentive allocated to the corresponding advertisement information can be decreased as much as provided to a corresponding user. In this embodiment, the offer of the incentive to a user may include a purchase of a corresponding goods or a win in a prize. For example, when a user makes a purchase of a goods, the corresponding incentive may be given to a user who buys the goods. Also, when a user runs a prize event of a certain advertisement information, the incentive may be given to a user by lot or the like. The lot may be drawn periodically or aperiodically, or a winner may be determined by counting visitors and selected as a user who reaches a predetermined count.

According to the present embodiment, since the amount of incentive decreases as the incentive is given to a user, the rank of the corresponding advertisement information becomes down temporarily, and correspondingly other advertisement informations may be ranked highly. Thus, the ranks of the plural advertisement informations are so flexibly changed that the advertisement access may further be decentralized.

However, the incentive varying factor according to the present embodiment is not limited to the foregoing description, and may vary. The incentive varying factor may be a condition previously set by an advertiser. For example, a predetermined amount of money may be given when the sales of goods reaches a predetermined sales volume, or a predetermined amount of money may be given to a user who completes a certain behavior such as answering to a quiz, a use postscript, introduction of another member, etc. Further, the incentive varying factor may be achieved in various forms such as a sales time, a sales period, a sales area, a purchase user age, a purchase user job, etc. The advertisement data output control system according to an exemplary embodiment of the present invention will be described with reference to FIG. 2. Referring to FIG. 2, the incentive in this embodiment may be the combined and accumulated reward points (hereinafter, also referred to as “combined reward points,” “accumulated reward points,” or “reward points”), which is disclosed in “MANY MEMBERS POINT ADDING SYSTEM FOR BUYING POINT OF THE BUYING MEMBER AND METHOD OF THE SAME (Korean Patent Application Nos. 10-2006-45900 and 10-2006-56655)” filed by the present applicant. In this embodiment, the accumulated reward points corresponding to a certain advertisement information increases as plural users click the certain advertisement information. Also, the accumulated reward points are used to give a discount off a purchase price when a user buys a goods on the corresponding advertisement information, thereby resulting in zero accumulated point. Thus, the accumulated reward points are varied as users click the advertisement information, and therefore the plurality of the advertisement informations may be changed in the rank. In FIG. 2, the accumulated reward points are displayed, but not limited thereto. Alternatively, the accumulated reward points may not be displayed.

In this embodiment, the amount of incentive may be determined by an increase rate previously set with respect to the advertisement information. The increase rate is to determine a changing degree of an incentive when the incentive varying factor occurs. Here, a ranking-up speed of an advertisement information having a high increase rate is relatively faster than that having a low increase rate. Accordingly, in this embodiment, the advertisement information having the higher increase rate occupies a higher rank more quickly, so that the advertisement fee can be more reasonably paid by allowing an advertiser to set up the increase rate at his/her disposal and to adjust the rank of the corresponding advertisement information. In the case of the accumulated reward points, the increase rate may be achieved in the form of a cumulative rate per click (hereinafter, referred to as “CPC”). The advertisement information, in which the CPC is set to be higher than that of other advertisement informations, gives more reward points as users click, so that it can more quickly enter the higher rank. On the other hand, the advertisement information having a low CPC enters the higher rank more slowly.

FIG. 2 illustrates examples of the CPC set for the advertisement informations from the second rank to the tenth rank in addition to the first rank advertisement information of which the CPC is set as 25% of a unit price of the goods. The advertisement data output control system with this embodiment arranges the advertisement in order from the high CPC to the low CPC at an initial condition where the accumulated reward points are not changed yet.

As described above, in this embodiment, the accumulated reward points are varied by the clicks of users, and the advertisement informations are rearranged in order of largely varied accumulated reward points. Further, the accumulated reward points are varied when a user makes a purchase or wins a prize.

For example, as shown in FIG. 2, if a goods corresponding to the first rank advertisement information is purchased, the accumulated reward points of 125,000 Won, given to the first rank advertisement information, is paid for a discount off the price of the corresponding goods, thereby resulting in zero accumulated point. Then, the advertisement data output control system according to the exemplary embodiment of the present embodiment transfers this advertisement information from the first rank to the lowest rank, and performs rearrangement for moving the second rank advertisement information to the first rank and raising all the following advertisement informations by one rank. The arrangement of the advertisement informations may be carried out in real time, periodically or aperiodically.

According to the present embodiment, the lower rank advertisement information may be raised up to the upper rank and may have a chance of being more accessed by users, thereby allowing an advertiser to pay a reasonable advertisement fee.

Alternatively, if the incentive is given to a user, the amount of the incentive remained after offer to a user (hereinafter, referred to as a “minimum residual incentive”) may be determined to secure a preset minimum money (hereinafter, referred to as a “minimum residual incentive” or a “reset reward point”). In other words, if the amount of incentive obtained by subtracting the incentive to be used from the current incentive is larger than the preset minimum residual incentive, the amount of residual incentive is determined in consideration of only the subtracted incentive as described in the above embodiment. On the other hand, if the amount of incentive is smaller than the minimum residual incentive, the residual incentive becomes the minimum residual incentive.

For example, referring to FIG. 2, let the minimum residual incentive, i.e., a reset reward point be set as 40,000 Won with regard to the first rank advertisement information. If a goods corresponding to the first rank advertisement information has a price of 200,000 Won, a currently accumulated reward points of 125,000 Won are all provided as a discount off the price. At this time, the accumulated reward points in which the subtracted incentive is reflected becomes zero, and is smaller than the reset reward point, i.e., smaller than the 40,000 Won, and therefore the final accumulated reward point becomes 40,000 Won as the reset reward points. In result, the first rank advertisement information is rearranged to secure the fourth rank higher than the fifth rank advertisement information of which accumulated reward point is 32,000 Won.

According to this embodiment, if the incentive is provided to a user and the residual incentive is largely decreased, the minimum incentive previously set regardless of the access is secured to thereby prevent the corresponding advertisement information from being rapidly ranked down. In this embodiment, the minimum residual incentive is set by a request of an advertiser or the like and previously set in a storage. For example, the minimum residual incentive may be set as an amount such as 10,000 Won or a predetermined rate such as 100% of a unit reward point.

As shown in FIG. 1, the advertisement data output control system may include advertiser terminals B1˜Bn to register the advertisement information and the CPC information in an advertisement data output control server (AOCS), pay the advertisement fee per click, and check the rank of the advertisement information concerned. Alternatively, the advertisement data output control system may not include the advertiser terminals B1˜Bn.

The advertisement data output control system in this embodiment may include user terminals A1˜An each of which is internally provided with a communication module such as a modem and a web browser to access the advertisement information and the accumulated reward point according to ranks which are registered in the AOCS, generate a purchase signal for a goods of a certain advertisement information, and make a purchase with a discount for a goods of the corresponding advertisement information as much as the accumulated reward points. Alternatively, the advertisement data output control system may not include the user terminals A1˜An.

Meanwhile, an online advertisement data output control system with this embodiment includes the AOCS which receives and registers the advertisement information and the CPC information from the advertiser terminals B1˜Bn; receives an access signal to the advertisement information from the user terminals A1˜An and accumulates the reward points corresponding to the CPC matched with each advertisement information; receives a purchase signal from the user terminals A1˜An and applies the accumulated reward points of the corresponding goods as a discount; and rearranges the advertisement information in order of the accumulated reward points.

The AOCS may selectively include a web server (WBS) to carry out web communication with the advertiser terminals B1˜Bn and the user terminals A1˜An.

In this embodiment, the advertisement information run in the AOCS may be linked with a site address (uniform resource locator, URL) of an advertiser corresponding to the advertisement information by a hypertext manner, so that the user terminals A1˜An can directly access the corresponding site. In this case, the AOCS determines that the corresponding advertisement information is clicked by a user, and processes the accumulated reward points to be accumulated. Further, in the case where a user directly makes a purchase, the accumulated reward points due to the purchase can be provided.

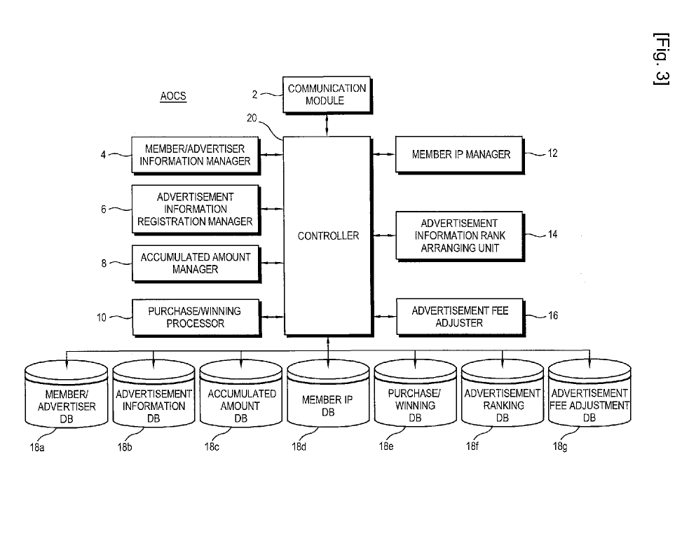

FIG. 3 is a block diagram of the AOCS according to an embodiment of the present invention. The AOCS according to this embodiment includes a communication module, a member/advertiser information manager, an advertisement information registration manager, an accumulated amount manager, a purchase/winning processor, a member Internet protocol (IP) manager, an advertisement information rank arranging unit, an advertisement fee adjuster, a member/advertiser database (DB), an advertisement information DB, an accumulated amount DB, a member IP DB, a purchase/winning DB, an advertisement ranking DB, an advertisement fee adjustment DE, and a controller.

A reference numeral of 2 indicates the communication module to receive the advertisement information and the CPC information from the advertiser terminals B1˜Bn and receive an advertisement click signal or a goods purchase signal from the user terminals A1˜An. In this embodiment, the communication module 2 is an example of a communication unit according to the present invention.

A reference numeral of 4 indicates the member/advertiser information manager to register and authenticate member information and advertiser information, and a reference numeral of 6 indicates the advertisement information registration manager to register and manage the advertisement information and the CPC information received from the advertisement terminals B1˜En.

A reference numeral of 8 indicates the accumulated amount manager that is linked with each advertisement information run in a home page or searched through a search box, gives the reward points when clicked, and processes the reward points of users to be accumulated according to goods, and sites. A reference numeral of 10 indicates the purchase/winning processor to manage whether a user makes a purchase and wins a prize as one of the factors that make the accumulated amounts to be varied through the accumulated amount manager.

A reference numeral of 12 indicates a member IP manager to process the clicks of the advertisement information, receive a purchase signal of an advertising goods and store and manage the IP or media access control (MAC) addresses, and cookies information of the members so as to accumulate the effective reward points. A reference numeral of 14 indicates an advertisement information rank arranging unit to arrange the advertisement informations in order of the large accumulated reward points in real time or by a unit of a predetermined time.

A reference numeral of 16 indicates the advertisement fee adjuster to calculate the advertisement fee corresponding to the click signal and the CPC information according to the advertisement information received from the user terminals A1˜An, and adjust the advertisement fee.

A reference numeral of 18a indicates the member/advertiser DB to register the member information and the advertiser information, a reference numeral of 18b indicates the advertisement information DB to store the advertisement information and the CPC information received from the advertiser terminals B1˜En, and a reference numeral of 18c indicates the accumulated amount DB linked with each advertisement information run in a home page or searched through a searching window so as to give the reward points when the advertisement information is clicked and accumulate and store the reward points of users according to goods and sites.

A reference numeral of 18d indicates the member IP DB to process the clicks of the advertisement information, receive the purchase signal of the advertising goods, and store the IP or MAC address and the cookies information of the member in order to accumulate the effective reward points, a reference numeral of 18f indicates the advertisement ranking DB to store the advertisement informations and their rank informations rearranged in real time or by a unit of a predetermined time, and a reference numeral of 18g indicates the advertisement fee adjustment DB to calculate the click signals according to the advertisement information received from the user terminals A1˜An and store information about the advertisement fee.

At least one of the member/advertiser DB 18a, the advertisement information DB 18b, the accumulated amount DB 18c, the member IP DB 18d, the purchase/winning DB 18e, the advertisement ranking DB 18f and the advertisement fee adjustment DB 18g is an example of the storage according to the present invention.

Meanwhile, a reference numeral of 20 indicates a controller to receive and register the advertisement information and the CPC information from the advertiser terminals B1˜Bn, accumulate the reward points in response to the received click signal to the advertisement from the user terminals A1˜An, and process the accumulated reward points to be paid and the advertisement informations to be rearranged in response to the received purchase signal.

Alternatively, at least one of the member/advertiser information manager 4, the advertisement information registration manager 6, the accumulated amount manager 8, the purchase/winning processor 10, the member IP manager 12, the advertisement information rank arranging unit 14, and the advertisement fee adjuster 16 may be included in the controller 20. According to an exemplary embodiment of the present invention, the controller may includes a read only memory (ROM) as a non-volatile memory, achievable through a hard disk drive or the like, to store a computer program programmed to perform the foregoing functions; a random access memory (RAM) as a volatile memory to which at least a part of the computer programs stored in the ROM is loaded; and a processor such as a central processing unit (CPU) to execute the computer program loaded to the RAM.

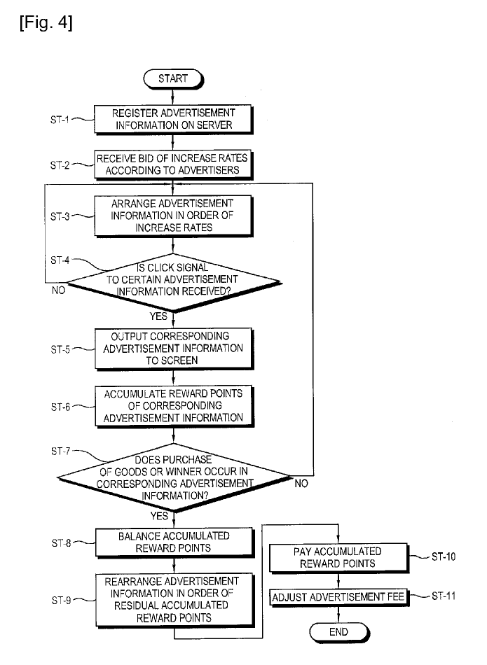

FIG. 4 is a flowchart showing operation of the advertisement data output control system according to an exemplary embodiment of the present invention. First, the AOCS according to this embodiment receives and registers the advertisement information from the advertiser terminals B1˜Bn (ST-1), and receives the CPC information from the advertiser terminals B1˜Bn to thereby invite bids (ST-2). The AOCS initially exhibits the advertisement informations arranged in order from a high CPC to a low CPC, thereby allowing a user to access the advertisement information (ST-3). The AOCS determines whether a click signal to a certain advertisement information is received from the user terminals A1˜An (ST-4), and loads and outputs the corresponding advertisement information to a screen when receiving the click signal to the certain advertisement information (ST-5).

When the advertisement information is clicked and therefore the reward points are generated by reflecting the preset CPC of the clicked advertisement information, the AOCS adds the generated reward points to the existing accumulated reward points (ST-6). Then, the AOCS rearranges the advertisement information in order of a large accumulated reward point.

The AOCS determines whether a purchase signal is generated for the corresponding advertising goods or anyone wins a prize (ST-7). If the purchase signal for the corresponding advertising goods is generated after the reward points of the corresponding advertising goods are accumulated, or if anyone wins a prize event of giving the accumulated reward points, the AOCS balances the accumulated reward points (ST-8).

The AOCS rearranges the advertisement informations in order of the high residual accumulated reward points (ST-9). The AOCS pay the accumulated reward points matched with the corresponding advertise information for a discount or a prize (ST-10), and adjusts the advertise fee of the corresponding advertiser (ST-11).

The adjustment of the advertisement fee may be fulfilled in real time, every day, every week, every month, etc., which is not necessary even though it is included in a series of processes.

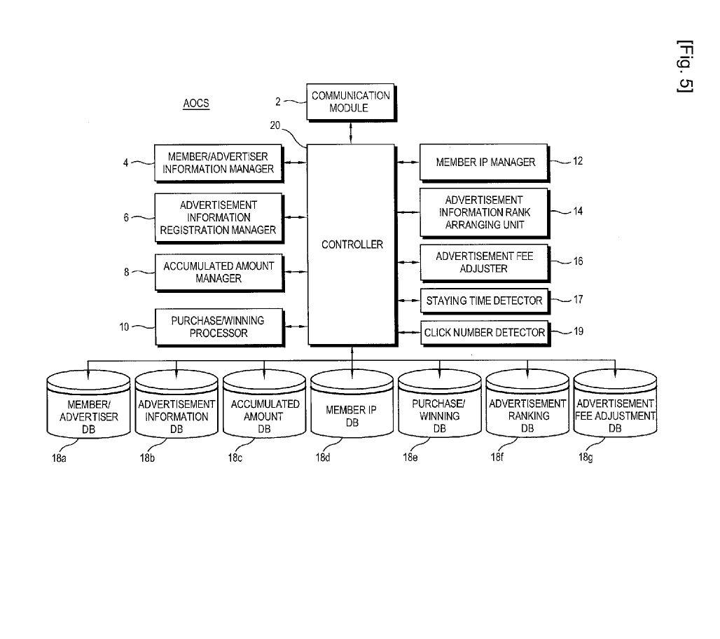

Below, an advertisement data output control system according to another exemplary embodiment of the present invention will be described with reference to the drawings. FIG. 5 is a block diagram showing configuration of an advertisement data output control server according to this exemplary embodiment of the present invention. While describing the advertisement data output control server shown in FIG. 5, repetitive descriptions of the same or the like configurations as those described referring to FIGS. 3 and 4 will be avoided.

In this embodiment, if the amount of user's access to a certain advertisement information is smaller than a predetermined value, the corresponding incentive stops varying. Referring to FIG. 5, the advertisement data output control system according to this embodiment provides the accumulated reward points only when a staying time is longer than a predetermined time after a user clicks the advertisement information, to thereby prevent a click fraud and allow an advertiser to pay a reasonable advertisement fee. In this embodiment, the staying time after a user clicks the advertisement information is an example of the amount of user's access.

That is, the advertisement data output control system according to this embodiment checks a staying time of a user according to each advertisement information, and provides the reward points to the advertisement information at which a user stays longer than a preset time. If the staying time does not reach the preset time, the reward points are not provided. Accordingly, the reward points can be selectively given to the advertisement information only accessed by a user who is considered for making a purchase.

The AOCS according to this embodiment includes a communication module, a member/advertiser information manager, an advertisement information registration manager, an accumulated amount manager, a purchase/winning processor, a member IP manager, an advertisement information rank arranging unit, an advertisement fee adjuster, a staying time detector, a click number detector, a member/advertiser DB, an advertisement information DB, an accumulated amount DB, a member IP DB, a purchase/winning DB, an advertisement ranking DB, an advertisement fee adjustment DB, and a controller.

A reference numeral of 17 refers to a staying time detector to start counting an access time of a certain advertisement information in response to a click signal of the corresponding advertisement information, and detect the staying time in response to a close signal of the corresponding advertisement information. A reference numeral of 19 refers to a click number detector linked with the accumulate amount manager 8, receiving the click signals corresponding to the certain advertisement information from the user terminal A1˜An and detecting the number of clicks according to the advertisement information. Alternatively, at least one of the staying time detector 17 and the click number detector 19 may be included in the controller 20.

Meanwhile, the controller 20 of this embodiment receives the click signals from the user terminals A1˜An and counts the staying time according to each advertisement information, thereby accumulating the reward points when the counted time is longer than the preset staying time.

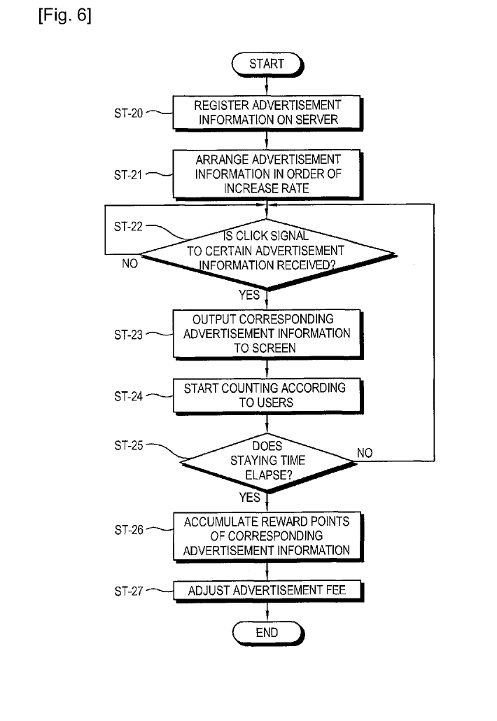

FIG. 6 is a flowchart showing operation of the advertisement data output control system according to another exemplary embodiment of the present invention. First, the AOCS according to this embodiment receives and registers the advertisement information from the advertiser terminals B1˜En (ST-20), and receives the CPC information from the same advertiser terminals B1˜Bn. In the beginning, the AOCS arranges the plurality of advertisement informations in order from a high CPC to a low CPC (ST-21).

The AOCS determines whether a click signal with regard to a certain advertisement information is received from the user terminals A1˜An (ST-22), and selects and outputs the corresponding advertisement information to a screen when the click signal to the certain advertisement information is received (ST-23). Then, the AOCS starts counting the staying time in the advertisement information according to users (ST-24).

Then, the AOCS determines whether a user stays in the corresponding advertisement information for a preset time (e.g., 10 seconds) or more, i.e., whether the staying time for accumulating the reward points elapses after a user accesses the corresponding advertisement information (ST-25).

If a user accesses the corresponding advertisement information for the preset staying time or more, the AOCS determines the reward points on the basis of the CPC of the corresponding advertisement information, and adds the determined reward points to the hitherto accumulated reward points (ST-26). Then, the AOCS adjusts the advertisement fee to be paid by the corresponding advertiser (ST-27).

Although it is not shown, the advertisement data output control system according to an exemplary embodiment of the present invention may determine the number of users concurrently connected to a certain advertisement information, and accumulates the reward points differentially according to the number of users. Further, the advertisement data output control system according to an exemplary embodiment of the present invention may reset the hitherto accumulated reward points (into 0 Won) if there is no purchase signal within a predetermined period of time. In this case, that the accumulated reward points are equal to or higher than a certain percentage of the selling price may be attached as a condition.

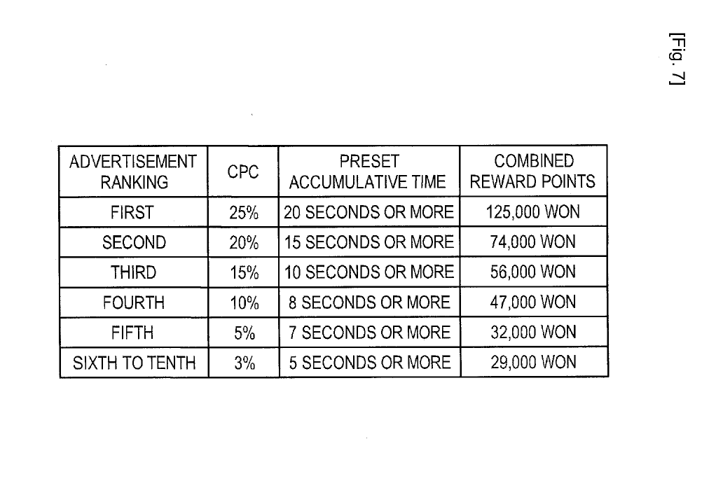

Below, an advertisement data output control system according to still another exemplary embodiment of the present invention will be described with reference to the drawing. FIG. 7 illustrates ranked advertisement information in an advertisement data output control system according to still another exemplary embodiment of the present invention.

In the advertisement data output control system of this embodiment, the ranks of the advertisement information may be set according to the minimum staying time allowed for accumulating the reward points. For example, as shown in FIG. 7, the staying times of 20 seconds, 15 seconds, 10 seconds, . . . may be designated to the first rank, the second rank, the third rank, and so on, respectively.

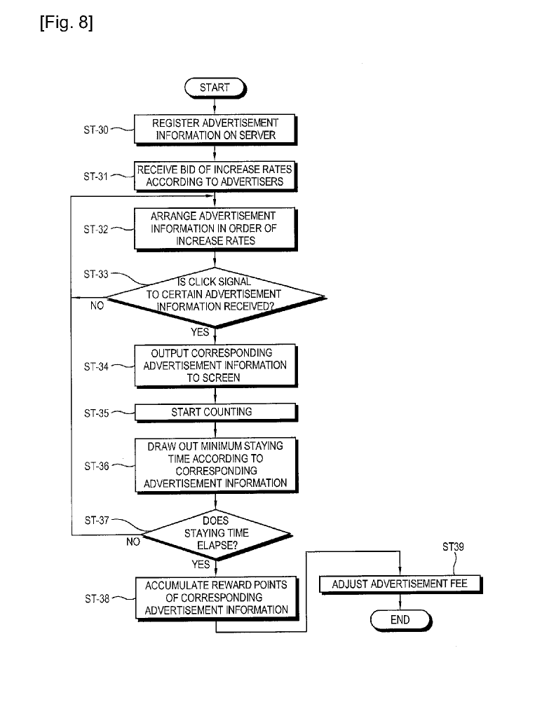

FIG. 8 is a flowchart showing operation of the advertisement data output control system according to still another exemplary embodiment of the present invention. The operations ST-30 to ST-35, and ST-37 to ST-39 in FIG. 8 are equal or similar to the operations ST-20 to ST-24, and ST-25 to ST-27 in FIG. 6, so that repetitive descriptions thereof will be avoided as necessary.

The AOCS in this embodiment determines the rank of the corresponding advertisement information, and reads the minimum staying time previously set according to the ranks by the advertiser of the corresponding advertisement information, thereby drawing out the minimum staying time corresponding to the rank at which the corresponding advertisement information is exhibited (ST-36).

In the advertisement data output control system according to this embodiment, the minimum staying time allowed for accumulating the reward points is set according to the ranks, so that the advertisement fee can be charged more reasonably. Further, the higher the rank of the advertisement, the longer a user has to access the corresponding advertisement information in order to accumulate the reward points. Accordingly, it is possible to set a proper accessing level required according to the rank.

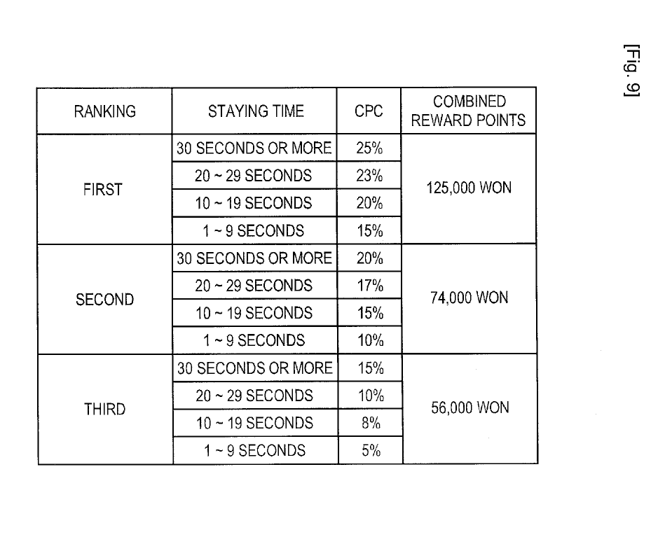

Below, an advertisement data output control system according to still another exemplary embodiment of the present invention will be described with reference to the drawing. FIG. 9 illustrates change in an increase rate in accordance with staying time in the advertisement data output control system according to still another exemplary embodiment of the present invention.

Referring to FIG. 9, the advertisement data output control system in this embodiment prepares the increase rates set differently according to the staying time with respect to a certain advertisement information, and varies the increase rate corresponding to the actual staying time with regard to the advertisement information. That is, as shown in FIG. 9, the longer a user stays, the higher the increase rate is applied. Accordingly, the reward points may more rapidly increase. In this embodiment, the amount of incentive increases depending on the amount of user's access, i.e., the length of the staying time. That is, the increase of the amount of user's access is reflected to the increase rate. Alternatively, the increase rate is not variable with regard to the staying time, but the reward points may be determined by the product of the staying time and the increase rate.

The AOCS in this embodiment receives and registers the advertisement information from the advertiser terminals B1˜Bn, and stores the CPC information according to the ranks, the staying times, etc. corresponding to the advertisement information in the form of a table as shown in FIG. 9. For example, in the case of the first rank, the CPC of 150, 200, 23% and 25% may be set to be applied to the staying time of about 1 second, about 10 seconds, about 20 seconds and about 30 or more seconds, respectively. Likewise, in the case of the second rank and the third rank, the CPC may be set differentially according to the staying time.

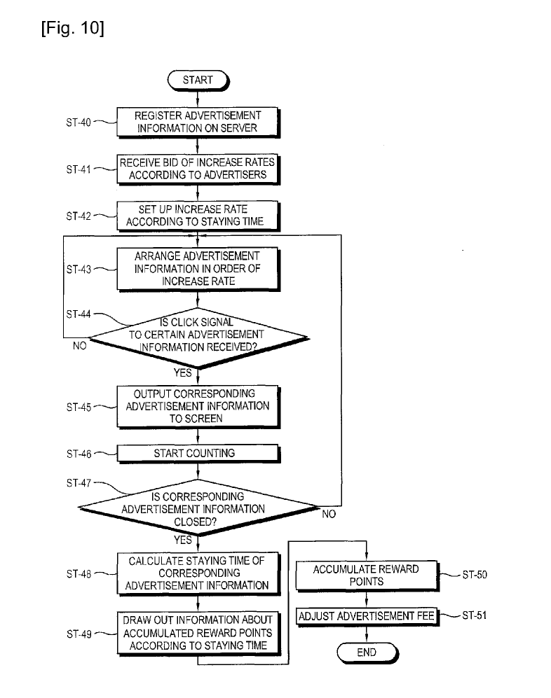

FIG. 10 is a flowchart showing operation of the advertisement data output control system according to still another exemplary embodiment of the present invention. Operations ST-40 to ST-46 and ST-50 to ST-51 in FIG. 10 are equal or similar to the operations ST-20 to ST-24 and ST-26 to ST-27 in FIG. 6, so that repetitive descriptions thereof will be avoided as necessary. If the staying time in the advertisement information is counted according to users, the AOCS determines whether the web page of the corresponding advertisement information accessed by the corresponding user is closed (ST-47).

If a user closes the web page of the corresponding advertisement information, the AOCS calculates the staying time in the corresponding advertisement information accessed by a user (ST-48), and determines the increase rate by determining the rank of the corresponding advertisement information and drawing out the CPC information set according to the ranks and the staying times.

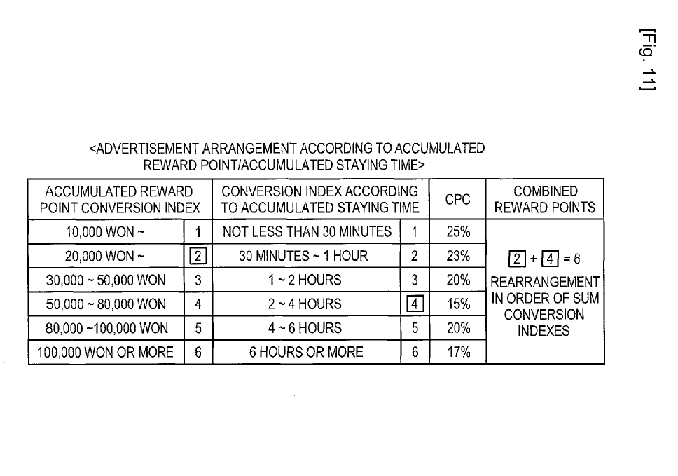

Below, an advertisement data output control system according to still another exemplary embodiment of the present invention will be described with reference to the drawing. FIG. 11 illustrates that the advertisement informations are arranged in order of precedence in the advertisement data output control system according to still another exemplary embodiment of the present invention.

Referring to FIG. 11, the advertisement data output control system according to this embodiment converts the user's staying time and the accumulated reward points into indexes, respectively, and arranges the advertisement information in order of the highly converted indexes.

Also, the advertisement data output control system according to an exemplary embodiment of the present invention may reflect weights on two factors such as the staying time of a user and the residual accumulated reward points to thereby set the conversion indexes. For example, as shown in FIG. 11, if the residual accumulated reward points are 25,000 Won and the accumulated staying time of a user is 3 hours with regard to a certain advertisement information (advertisement information A), the residual accumulated reward points and the accumulated staying time with regard to the corresponding advertisement information are converted into “2” and “4” as the conversion indexes. Accordingly, the sum of conversion indexes with respect to the corresponding advertisement information is “6”. If the sum of conversion indexes with regard to another advertisement information (advertisement information B) is “4”, the advertisement information A is ranked higher than the advertisement information B. In this embodiment, the accumulated staying time corresponds to total time taken in accessing the corresponding advertisement information by a user continuously or intermittently. The table data shown in FIG. 11 may be stored in the storage of the advertisement data output control system.

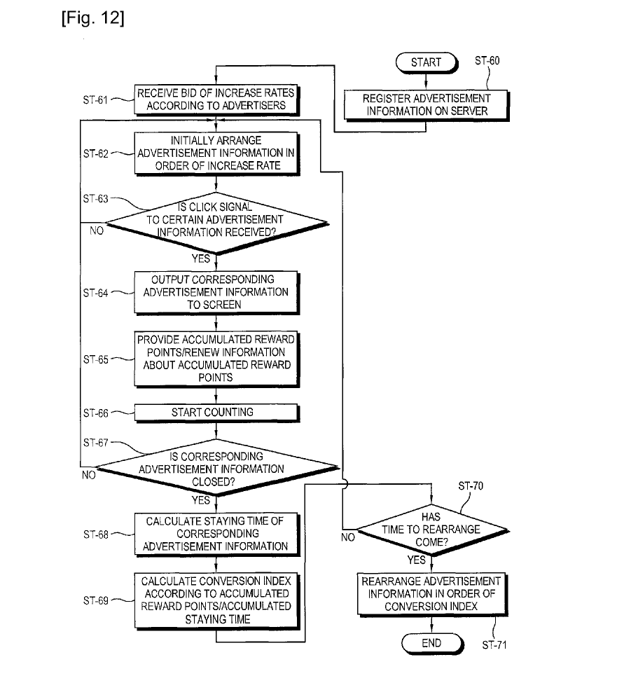

FIG. 12 is a flowchart showing operation of the advertisement data output control system according to still another exemplary embodiment of the present invention. Operations ST-60 to ST-67 in FIG. 12 are equal to or similar to the operations ST-40 to ST-47 in FIG. 10, and thus repetitive descriptions thereof will be avoided as necessary.

If a user closes the web page of the corresponding advertisement information (NO in ST-67), the AOCS calculates the staying time in the corresponding advertisement information accessed by a user, and renews the accumulated staying time information of the corresponding advertisement information (ST-68). The AOCS performs the conversion to thereby convert the accumulated reward points and the accumulated staying time with regard to the corresponding advertisement information into the conversion indexes (ST-69).

The AOCS determines whether it reaches a preset time for rearranging the advertisement informations (ST-70), and rearranges the advertisement informations in order of a high conversion index converted from the accumulated reward points and the accumulated staying time if it is the preset time for the rearrangement (ST-71).

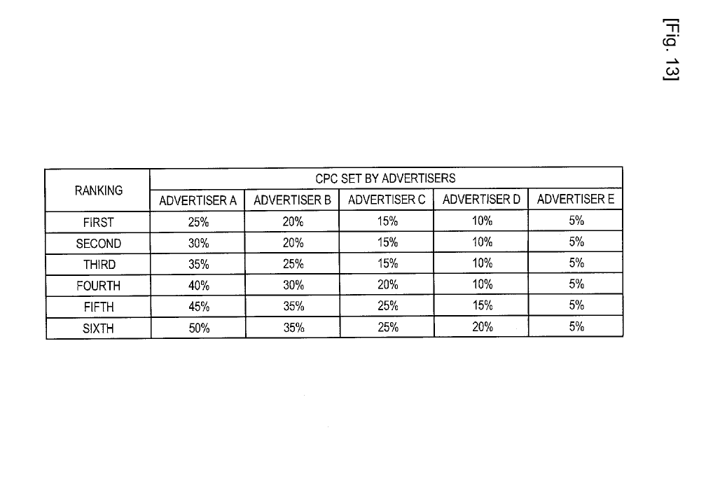

Below, an advertisement data output control system according to still another exemplary embodiment of the present invention will be described with reference to the drawing. FIG. 13 illustrates change in an increase rate in the advertisement data output control system according to still another exemplary embodiment of the present invention. Referring to FIG. 13, in the advertisement data output control system according to this embodiment, the increase rate may be set according to the ranks of the advertisement informations. That is, according to the advertisement data output control system in this embodiment, the lower ranked advertisement information can be set to more quickly move to the higher rank by applying the higher increase rate to the lower ranked advertisement information, so that the advertisement fee can be more reasonably charged.

The AOCS in this embodiment may store table data as shown in FIG. 13. In this embodiment, the increase rate may be set differently according to the advertisers (refer to FIG. 13).

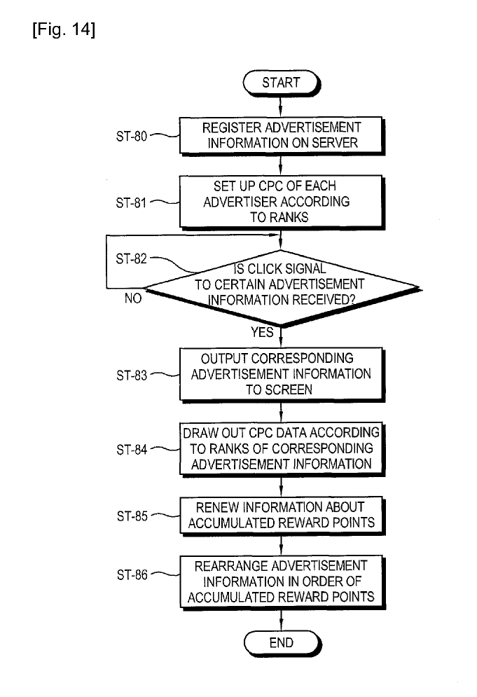

FIG. 14 is a flowchart showing operation of the advertisement data output control system according to still another exemplary embodiment of the present invention. First, the AOCS in this embodiment receives and registers the advertisement information from the advertiser terminals B1˜Bn (ST-80), and sets up the CPC information according to the ranks of the advertisement information previously set by an advertiser (ST-81). The AOCS determines and arranges the ranks of the plural advertisement information in order of a high CPC.

The AOCS determines whether a click signal with regard to a certain advertisement information is received from the user terminals A1˜An (ST-82), and draws out and outputs the corresponding advertisement information to the screen if the click signal to the certain advertisement information is received (ST-83). The AOCS draws out the CPC information according to the ranks previously set corresponding to the advertisement information, thereby calculating the reward points given as a corresponding user clicks the corresponding advertisement information (ST-84).

Then, the AOCS accumulates the reward points on the basis of the CPC information according to the ranks of the corresponding advertisement information, and renews the information about the accumulated reward points of the corresponding advertisement information (ST-85). The AOCS rearranges the ranks of the plural advertisement informations in order of high residual accumulated reward points (ST-86).

Alternatively, the increase rate may be adjusted according to a predetermined increase rate adjusting factor. For example, in this embodiment, the increase rate adjusting factor includes a case that the advertisement fee to the sales exceeds a predetermined value. The AOCS in this embodiment renews the information about the increase rate stored in the storage so that the increase rate of the corresponding advertisement information can be adjusted to become higher when a predetermined increase rate adjusting factor occurs. According to this embodiment, if there is needed to adjust the increase rate according to rules based on request of an advertiser, e.g., if the sales to the advertisement fee is low, etc. the increase rate of the corresponding advertisement information is adjusted to increase, thereby allowing the advertisement information to move to the higher rank more quickly.

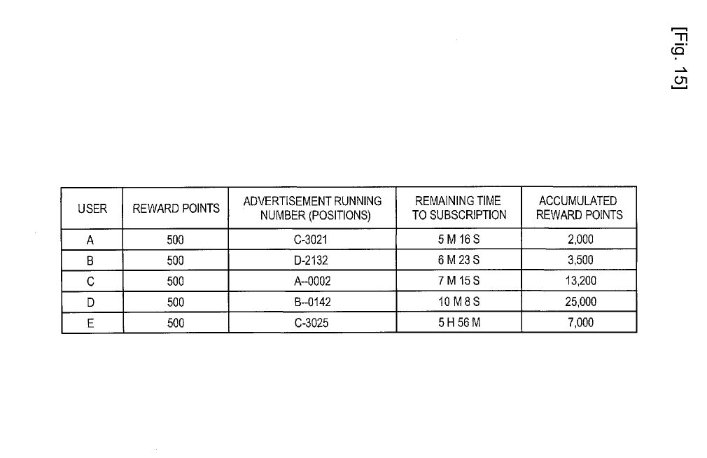

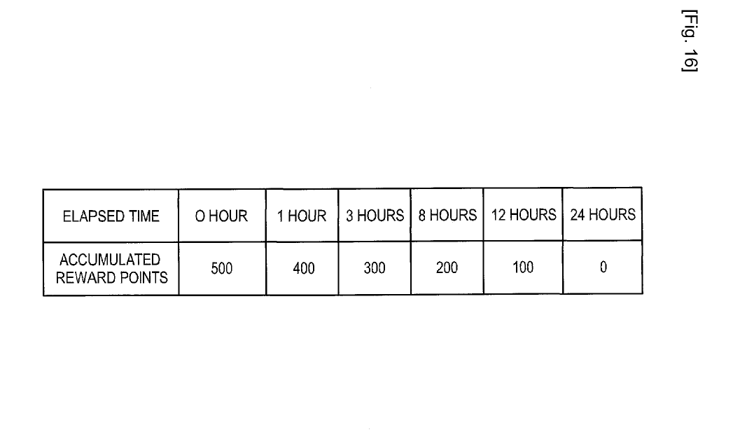

Below, an advertisement data output control system according to still another exemplary embodiment of the present invention will be described with reference to the drawing. FIG. 15 illustrates a state of counting an accummulatable subscription time in the advertisement data output control system according to still another exemplary embodiment of the present invention, and FIG. 16 illustrates change in accummulatable reward points according to a lapse of time in the advertisement data output control system according to still another exemplary embodiment of the present invention.

Referring to FIGS. 15 and 16, the advertisement data output control system may be set to restrict a time for a user to make a purchase or an application with regard to the advertisement information so as to receive the reward points, or may be set to decrease the reward points as time goes by after clicking the corresponding advertisement information. For example, as shown in FIG. 15, in order to receive 500 Won, a user A has to make a purchase or an application within 5 minutes 16 seconds after clicking the advertisement information of a code C-3021. Alternatively, as shown in FIG. 16, the reward points of 500 Won generated in the beginning of clicking the advertisement may be gradually decreased as time elapses. For example, the reward points may be decreased into 300 Won for purchasing after three hours elapses.

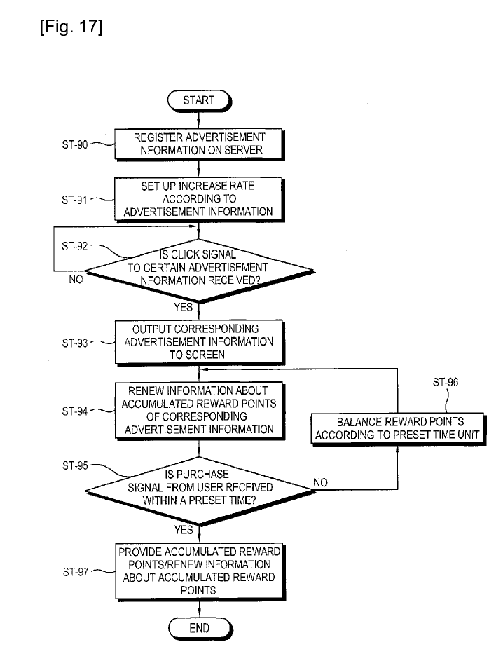

FIG. 17 is a flowchart showing operation of the advertisement data output control system according to still another exemplary embodiment of the present invention. Operations ST-90 to ST-93 in FIG. 17 are equal to or similar to the operations ST-80 to ST-83 in FIG. 14, and thus repetitive descriptions thereof will be avoided as necessary.

The AOCS draws out the CPC information of a certain advertisement information if there is an access to the corresponding advertisement information, and accumulates the reward points given by the corresponding clicks of users, thereby renewing information about the accumulated reward points (ST-94).

Then, the AOCS determines whether a purchase signal from a corresponding user is generated within a time previously set by the advertiser of the corresponding advertisement information (ST-95). If there is no purchase signal from the user within the preset time, the AOCS reduces the previously given reward points according to a set lapse of time, and returns to a stage of renewing the information about the accumulated reward points (ST-96). On the other hand, if there is a purchase signal, the AOCS pays the corresponding accumulated reward points and resets the information about the corresponding accumulated reward points (into 0 Won) (ST-97).

According to the advertisement data output control system in this embodiment, the reward points are decreased as time for the purchase goes by, so that a user can be induced to quickly make a purchase, and an advertiser can save the reward points wastefully paid for a user who does not make a purchase, thereby allowing an advertiser to pay a reasonable advertisement fee.

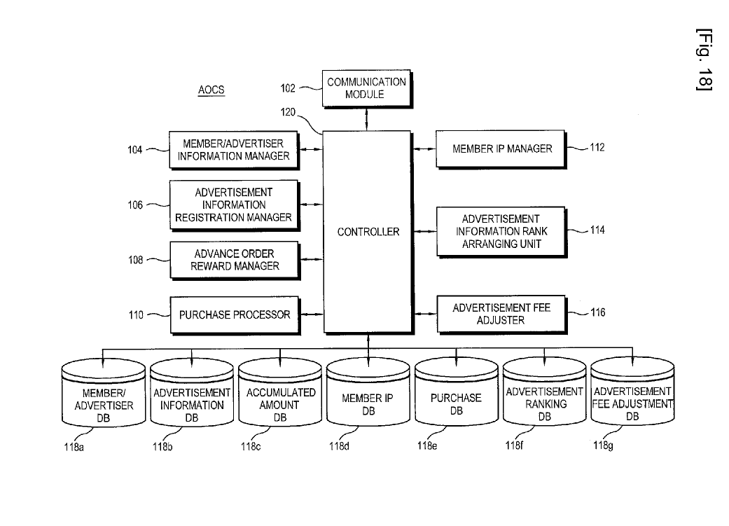

Below, an advertisement data output control system according to still another exemplary embodiment of the present invention will be described with reference to the drawing. FIG. 18 is a block diagram showing configuration of the advertisement data output control server according to still another exemplary embodiment of the present invention. The advertisement data out control server shown in FIG. 18 have the same or similar configurations as those of the advertisement data output control server described with reference to FIGS. 3 and 4, and thus repetitive descriptions thereof will be avoided as necessary.

Referring to FIG. 18, the advertisement data output control system according to this embodiment provides a user with the corresponding reward points under the condition of his/her advance order. That is, in the advertisement data output control system in this embodiment, if a user pays an amount corresponding to the provided reward points as a deposit for a purchase, the corresponding reward points are provided when a user buys the corresponding goods. Accordingly, in this embodiment, from the advertisement's standpoint the reward points are paid for a user who actually makes a purchase, the payment of the advertisement fee is reasonable.

The AOCS according to this embodiment includes a communication module, a member/advertiser information manager, an advance order supporting amount manager, a purchase processor, a member IP manager, an advertisement information rank arranging unit, an advertisement fee adjuster, a member/advertiser DB, an advertisement information DB, an advance order reward DB, a member IP DB, a purchase DB, an advertisement ranking DB, an advertisement fee adjustment DB, and a controller. Alternatively, at least one of the communication module, a member/advertiser information manager, an advance order supporting amount manager, a purchase processor, a member IP manager, an advertisement information rank arranging unit, and the advertisement fee adjuster may be included in the controller. In this embodiment, “advance order reward”, “purchase support reward”, “support reward” or “reward” may be an example of the incentive.

Reference numerals of 102 to 106 correspond to 2 to 6 of FIG. 3, respectively. A reference numeral of 108 refers to an advance order reward manager to receive and manage the information about an advance order reward of the goods run in the advertisement from the advertiser terminals B1˜Bn. A reference numeral of 110 refers to a purchase processor to process a user's purchase and to calculate a final purchase price with regard to the goods run in the advertisement.

Reference numerals of 112 to 116 correspond to 12 to of FIG. 3 Reference numerals of 118a to 118g correspond to 18a to 18g of FIG. 3. Exceptionally, a reference numeral 118c refers to the advance order reward DB to store information about the advance order reward with respect to the goods run in the advertisement, a reference numeral of 118e refers to a purchase DB to store information about the process of a user's purchase and a final purchase price, and information about a user's purchase.

A reference numeral of 120 refers to a controller that receives and registers the advertisement information and the advance order reward information from the advertiser terminal E1˜En; calculates and provides an advance order amount and an advance order discount in response to an advertisement click signal and an advance ordering signal from a user terminal A1˜An; and renews the advertisement information and the advance order information and processes the purchase on the basis of the final purchase price calculated and input by reflecting a discount when processing the purchase.

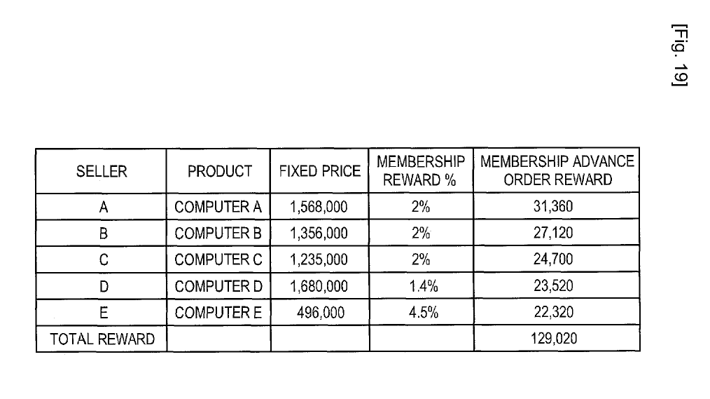

FIG. 19 illustrates settlement of accounts in consideration of a deposit when securing advance payment in the advertisement data output control system according to still another exemplary embodiment of the present invention. Referring to FIG. 19, the AOCS in this embodiment stores information about the advance order reward according to goods run in each advertisement information set by an advertiser, in the form of searchable table data.

For example, if a “computer” is input to a search box, five advertisement informations are listed in order of ranks, in which information about the computer provided by each seller, a fixed price of the corresponding computer, an advance order supporting rate about the fixed price, an advance order reward and a total reward are output. In this embodiment, the total reward is an amount that a user has to previously pay for a purchase deposit.

In the advertisement data output control system with this embodiment, a user can receive a purchase reward when making a purchase only after transferring the corresponding purchase deposit. When a user makes a purchase, the AOCS calculates a settlement price of the corresponding goods in consideration of the purchase deposit paid by a user. Here, the settlement price of the goods can be obtained by subtracting the purchase deposit of a user or the purchase reward provided to a user from the fixed price.

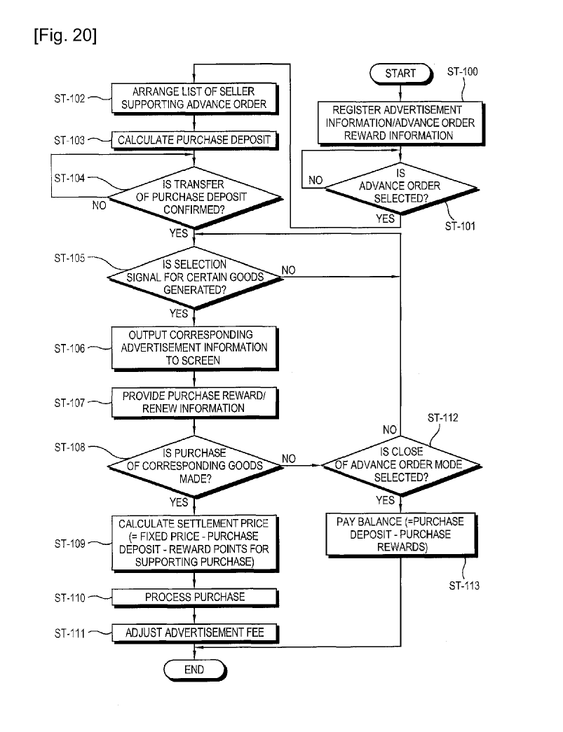

FIG. 20 is a flowchart showing operation of the advertisement data output control system according to still another exemplary embodiment of the present invention. First, the AOCS receives and sets up the advertisement information and the advance order reward information from the advertiser terminal B1˜Bn (ST-100). The AOCS matches and registers the advertisement information according to search words. The AOCS receives an input signal about a search word for a certain goods from the user terminal A1˜An, and transmits the advertisement information matched with the corresponding search word to the corresponding user terminal A1˜An, thereby outputting it on the screen.

The AOCS determines whether a selection signal for an advance order is received from the user terminal A1˜An (ST-101). When the selection signal for the advance order is received, the AOCS calculates the purchase deposit obtaining by summing the advance order rewards from the advertisement informations matched with the corresponding search word and output to the screen, thereby informing the user of the purchase deposit (ST-102 and ST103).

The AOCS determines whether the corresponding purchase deposit is transferred or not (ST-104). When the transfer is confirmed, the AOCS determines whether a selection signal for a certain goods is generated from the user terminals A1˜An (ST-105).

After the selection signal is generated for a certain goods, the AOCS transmits information about the corresponding goods to the user terminals A1˜An, thereby outputting it the screen (ST-016). If there is an access to a certain advertisement information, the AOCS draws out the CPC information of the corresponding advertisement information, accumulates the reward points given by the corresponding access, and renews the information about the accumulated reward points (ST-107).

The AOCS determines whether a purchase signal for the corresponding goods is received from the user terminal A1˜An (ST-108). When the purchase signal for the corresponding goods is received, the AOCS calculates and informs a user of the settlement price (=fixed price−purchase deposit−reward points for supporting the purchase) (ST-109), and performs the purchase process after confirming the money transfer (ST-110). Then, the AOCS settles the advertisement fee with the advertiser (ST-111).

If there is no purchase signal from the user terminal A1˜An, the AOCS determines whether a close signal of an advance order mode is received from the user terminal A1˜An (ST-112). If the close signal of the advance order mode is received, the balance (=purchase deposit−purchase rewards of non-accessed goods being advertised) is calculated and paid (ST-113). In the operation ST-112, if there is no close signal for the advance order mode, the operation is returned to a stage for accessing the information of the advertising goods.

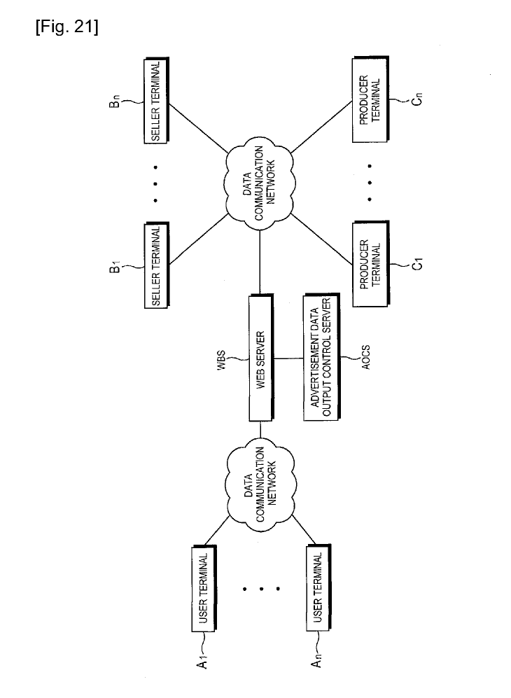

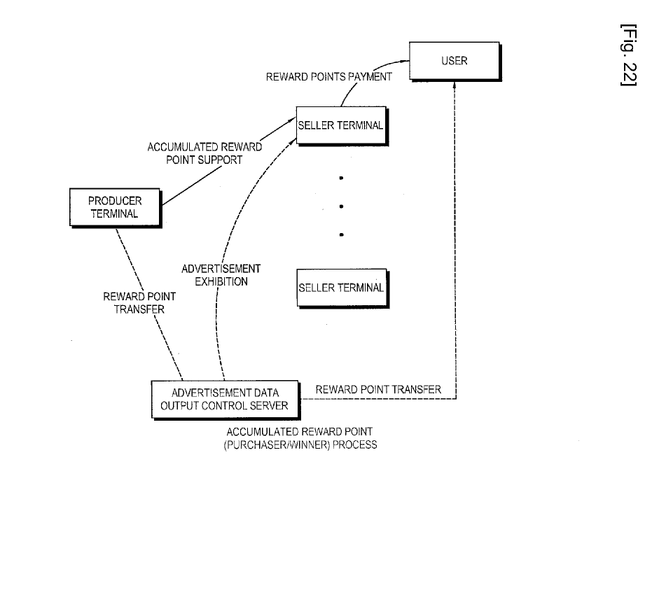

Below, an advertisement data output control system according to still another exemplary embodiment of the present invention will be described with reference to the drawing. FIG. 21 is a schematic view of an advertisement data output control system according to still another exemplary embodiment of the present invention, and FIG. 22 illustrates state of an advertisement data output control system according to still another exemplary embodiment of the present invention. Below, the advertisement data output control system shown in FIG. 21 will be described avoiding repetitive descriptions as compared with that described with reference to FIG. 1.

Referring to FIGS. 21 and 22, in the online advertisement data output control system in this embodiment, when a user clicks the advertisement information run in the site of the seller, a producer supports the accumulated reward points to the seller.

Producer terminals C1˜Cn transmits and registers information about support of the accumulated reward points to the AOCS, and transfers costs for supporting the accumulated amount per clicks of a user to the producer goods run in the site of the seller (i.e., the corresponding advertiser).

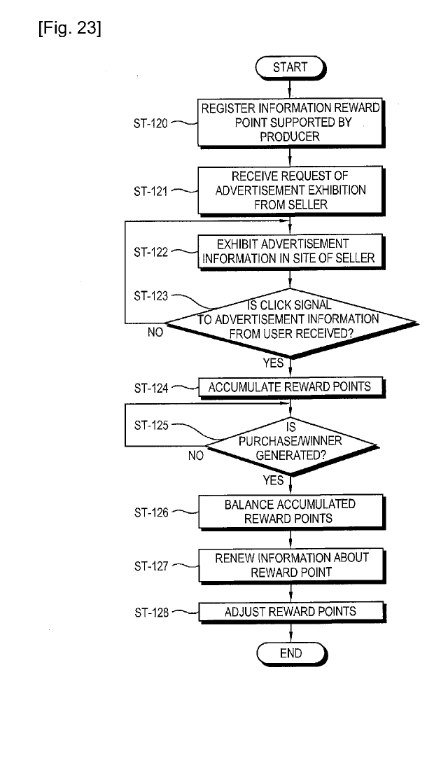

FIG. 23 is a flowchart showing operation of the advertisement data output control system according to still another exemplary embodiment of the present invention. First, the AOCS in this embodiment receives and registers sales goods information and reward information per clicks of a user from the producer terminals C1˜Cn (ST-120). The reward information includes information that how much advertisement fee is paid by a producer to the seller per goods when the producer's goods is exhibited on the site of the seller.

The advertisement data output control server AOCS receives a request signal for exhibiting the corresponding producer's goods from seller terminals B1˜Bn (ST-121), and then exhibits the advertisement information of the corresponding producer's goods in the site of the corresponding seller (ST-122). The AOCS determines whether a click signal to a certain advertisement information is received from the user terminal A1˜An (ST-123), and draws out the corresponding advertisement information when the click signal to the certain advertisement information is received, thereby outputting it to the screen. The AOCS draws out the CPC information of the corresponding advertisement information and accumulates the reward points given due to the clicks of the corresponding user to the advertisement information, thereby renewing the information about the accumulated reward points (ST-124).

The AOCS determines whether a purchase signal of the corresponding user or a winner designating signal is generated (ST-125). If the purchase signal is generated, the AOCS balances the corresponding accumulated reward points (ST-126), renews the information about the accumulated reward points (ST-127), and adjusts the corresponding accumulated reward points together with the producer (ST-128).

According to an exemplary embodiment of the present invention, the producer effectively sales the products even though he/she has no sales network, and also the seller receives the advertisement fee backing from the producer and fulfills effective marketing, thereby increasing the sales.

According to another exemplary embodiment of the present invention, a predetermined auxiliary incentive may be given to a user having an access to the advertisement information. The auxiliary incentive in this embodiment is similar to the foregoing incentive in light of benefits to a user, but somewhat different from the foregoing incentive in light of its specific object. Hereinafter, the foregoing incentive will be called a “basic incentive” distinguished from the auxiliary incentive. In respect of describing the advertisement data output control system in this embodiment, the same or like elements as those of the foregoing embodiments will be omitted.

In the state that the basic incentive is given to a first user who buys a goods, the auxiliary incentive in this embodiment is given to at least one second user who has an access to the advertisement information of the corresponding goods before the first user makes the purchase and buys the corresponding goods after the first user makes the purchase. The auxiliary incentive in this embodiment may be applied if a time gap exists between the access to the advertisement information providing the basic incentive and the actual purchase of the corresponding goods. For example, the access to the advertisement information may be achieved in a first web page where a plurality of advertisement informations are listed, but the purchase of the goods may be achieved in a second web page corresponding to one selected among the plurality of advertisement informations. In this embodiment, the access to the advertisement information includes a user's specific behavior such as clicking the advertisement information exhibited on the first web page so as to move the second page for the purpose of buying the goods. In this case, there is a predetermined time gap between a first click to the advertisement information exhibited on the first web page and a second click for actually buying the corresponding goods on the second web page. Due to such a time gap, there may be a second user who clicks one goods of the corresponding advertisement information exhibited on the first web page to receive the basic incentive between the first click and the second click of first user. In this embodiment, since the basic incentive has already been given to the first user, the second user receives the auxiliary incentive, thereby not only providing a proper compensation to a user who has already had the access to the advertisement information but also promoting the sales of the goods. In this embodiment, the auxiliary incentive may be given to each second users who makes a purchase, in the case of the plurality of second users.

Like the basic incentive, the auxiliary incentive in this embodiment may be achieved as a discount off the price of the goods. The amount of auxiliary incentive may be set to be smaller than that of the basic incentive of the corresponding advertisement information. For example, the amount of auxiliary incentive may be 40% to 90% of the basic incentive. Alternatively, the amount of auxiliary incentive may be set to become larger as the price of the goods increases. Also, the amount of auxiliary incentive may be determined according to the number of second users connected to the second web page. For example, the more the number of second users connected to the second web page, the more the amount of auxiliary incentive. Further, the amount of auxiliary incentive may be correspondingly decreased according to the respective purchase of the plural second users. Also, there may be a predetermined limit to the auxiliary incentive. For example, sum of the basic incentive and the auxiliary incentive with regard to a certain advertisement information may be set not to exceed a predetermined value set by an advertiser.

[Table 1] exemplarily shows a table where the amount of auxiliary incentive is set according to this embodiment.

TABLE 1

| reward | users | | | | |
|---|---|---|---|---|---|
| (Won) | 5 or less | 6~10 | 11~15 | 16~20 | 21 or more |
| 10,000 or less | 40% | 45% | 50% | 55% | 60% |
| 10,000~30,000 | 45% | 50% | 55% | 60% | 65% |
| 30,001~50,000 | 50% | 55% | 60% | 65% | 70% |
| 50,001~100,000 | 55% | 60% | 65% | 70% | 75% |
| 100,001~500,000 | 60% | 65% | 70% | 75% | 80% |
| 500,001~1,000,000 | 65% | 70% | 75% | 80% | 85% |
| 1,000,001 or more | 70% | 75% | 80% | 85% | 90% |

In [Table 1], “users” indicates the number of second users connected to the second web page, and the “reward” indicates the basic incentive or the auxiliary incentive to be provided for a user. As shown in [Table 1], if fifteen users are connected in the state that the basic incentive is 100,000 Won, the first user receives the basis incentive, the second user of the next first receives an auxiliary incentive of 65,000 Won as 65% of 100,000 Won, the second user of the next second receives an auxiliary incentive of 42,250 Won as 65% of 65,000 Won, the second user of the next third receives an auxiliary incentive of 25,350 Won as 60% of 42,250 Won, and so on.

The storage of the AOCS according to an exemplary embodiment of the present invention may store the information about the auxiliary incentive. Further, the AOCS according to an exemplary embodiment of the present invention may exhibit the information about the auxiliary incentive on the second web page if there is a purchase request of the second user between the purchase request and the purchase execution of the first user. The information about the auxiliary incentive includes the contents and the amount of the auxiliary incentive. In this embodiment, the ROCS implements the processes related to the auxiliary incentive so as to provide the corresponding auxiliary incentive when a second user makes a purchase. The advertisement data output control system with the characteristics regarding to the auxiliary incentive in this embodiment may include or exclude the foregoing characteristics of ranking the advertisement informations.

In the meantime, an on-line advertisement data output control system and a method of the same according to an exemplary embodiment of the present invention are not limited to the foregoing embodiments, and may vary without departing from the principles and spirit of the present invention.

1. An advertisement data output control system comprising:
a communication unit which communicates with a user terminal;
a storage which stores a plurality of advertisement informations and incentive informations corresponding to the plurality of advertisement informations, respectively; and
a controller which renews the incentive information to vary the amount of incentive corresponding to the advertisement information concerned according to predetermined incentive varying factor, and controls the plurality of advertisement informations to be arranged in order of the amount of incentive and displayed in the user terminal.

2. The advertisement data output control system according to claim 1, wherein the incentive varying factor comprises at least one user's access to the advertisement information, and
the amount of incentive increases depending on the amount of user's access to the corresponding advertisement information.

3. The advertisement data output control system according to claim 2, wherein the controller stops variation of the corresponding incentive if the amount of user's access to a certain advertisement information is less than a predetermined value.

4. The advertisement data output control system according to claim 1, wherein the storage further stores information about an increase rate previously set with respect to each of the plural advertisement informations, and
the controller determines the amount of incentive on the basis of the increase rate.

5. The advertisement data output control system according to claim 4, wherein the increase rates of the plural advertisement informations are set differentially according to ranks of the plural advertisement informations.

6. The advertisement data output control system according to claim 4, wherein the controller renews the information about the increase rate so that the increase rate is adjusted with respect to the corresponding advertisement information according to a predetermined increase rate adjusting factor.

7. The advertisement data output control system according to claim 1, wherein the incentive varying factor comprises providing the incentive to the user, and
the controller reduces the incentive as much as provided to the corresponding user.

8. The advertisement data output control system according to claim 7, wherein the controller secures the amount of incentive remained after providing the incentive to be not less than a predetermined minimum value.

9. The advertisement data output control system according to claim 7, wherein if the incentive is provided to a first user who makes a purchase of a goods, the controller fulfills an auxiliary incentive process to provide an auxiliary incentive to a second user who has an access to the advertisement information of the corresponding goods before the purchase of the first user and makes a purchase of the corresponding goods after the purchase of the first user.

10. The advertisement data output control system according to claim 1, wherein the controller controls the user terminal to display the amount of incentive to correspond to the advertisement information concerned.

11. The advertisement data output control system according to claim 1, wherein the controller draws out plural advertisement informations corresponding to a search request of a user from the plurality of advertisement informations, and controls the drawn plural advertisement informations to be displayed through the user terminal.

12. An advertisement data output control method of an advertisement data output control system, the method comprising:
storing a plurality of advertisement informations and incentive informations corresponding to the plurality of advertisement informations, respectively;
renewing the incentive information to vary the amount of incentive corresponding to the advertisement information concerned according to a predetermined incentive varying factor; and
controlling the plurality of advertisement informations to be arranged in order of the amount of incentive and displayed in the user terminal.

13. The advertisement data output control method according to claim 12, wherein the incentive varying factor comprises at least one user's access to the advertisement information, and
the amount of incentive increases depending on the amount of user's access to the corresponding advertisement information.

14. The advertisement data output control method according to claim 13, wherein the renewing the incentive information comprises stopping variation of the corresponding incentive if the amount of user's access to a certain advertisement information is less than a predetermined value.

15. The advertisement data output control method according to claim 12, wherein the renewing of the incentive information comprises determining the amount of incentive on the basis of an increase rate previously set with respect to each of the plural advertisement informations.

16. The advertisement data output control method according to claim 15, wherein the increase rates of the plural advertisement informations are set differentially according to ranks of the plural advertisement informations

17. The advertisement data output control method according to claim 15, wherein the renewing of the incentive information comprises adjusting the increase rate with respect to the corresponding advertisement information according to a predetermined increase rate adjusting factor.

18. The advertisement data output control method according to claim 12, wherein the incentive varying factor comprises providing the incentive to the user, and
the renewing of the incentive information comprises reducing the incentive as much as provided to the corresponding user.

19. The advertisement data output control method according to claim 15, wherein the renewing of the incentive information comprises securing the amount of incentive remained after providing the incentive to be not less than a predetermined minimum value.

20. The advertisement data output control method according to claim 18, wherein if the incentive is provided to a first user who makes a purchase of a goods, the method further comprising fulfilling an auxiliary incentive process to provide an auxiliary incentive to a second user who has an access to the advertisement information of the corresponding goods before the purchase of the first user and makes a purchase of the corresponding goods after the purchase of the first user.

21. The advertisement data output control method according to claim 12, wherein the controlling of the plurality of advertisement informations comprises displaying the amount of incentive to correspond to the concerned advertisement information in the user terminal.

22. The advertisement data output control method according to claim 12, wherein the controlling of the plurality of advertisement informations comprises displaying plural advertisement informations corresponding to a search request of a user drawn out from the plurality of advertisement informations, through the user terminal.

23. An advertisement data output control system comprising:
a communication unit which communicates with a plurality of users through user terminals;
a storage which stores an advertisement information of a goods, and information about a basic incentive and an auxiliary incentive; and
a controller which processes the information about the basic incentive and the auxiliary incentive so that the basic incentive is provided to a first user who makes a purchase of a goods through an access to the advertisement information among the plurality of users, and the auxiliary incentive is provided to a second user who has an access to the advertisement information of the corresponding goods before the purchase of the first user and makes a purchase of the corresponding goods after the purchase of the first user.

24. An advertisement data output control method of an advertisement data output control system, the method comprising:
storing an advertisement information of a goods, and information about a basic incentive and an auxiliary incentive;
processing the information about the basic incentive so that the basic incentive is provided to a first user who makes a purchase of a goods through an access to the advertisement information among the plurality of users; and
processing the information about the auxiliary incentive so that the auxiliary incentive is provided to a second user who has an access to the advertisement information of the corresponding goods before the purchase of the first user and makes a purchase of the corresponding goods after the purchase of the first user.
